(19) United States
(12) Patent Application Publication
(10) Pub. No.: US 2026/0073301 A1
(43) Pub. Date: Mar. 12, 2026

(54) MACHINE LEARNING MODEL INPUT MONITOR

(71) Applicant: AUMOVIO Autonomous Mobility Germany GmbH, Ingolstadt (DE)

(72) Inventors: Mert Keser, Berlin (DE); Erwin Kraft, Frankfurt am Main (DE)

(21) Appl. No.: 19/314,159

(22) Filed: Aug. 29, 2025

(30) Foreign Application Priority Data
Sep. 3, 2024 (DE) 10 2024 208 360.7

(51) Int. Cl. G06N 20/00

(52) U.S. Cl. CPC G06N 20/00

(57) ABSTRACT

A trained vision foundation model and a training data set used for training of the machine learning model are provided. For each training image of the training data set, a training data feature vector is determined using the vision foundation model. A distribution of the training data feature vectors is determined, An image depicting a scene is received. An image feature vector is determined for the image using the vision foundation model. A log likelihood is computed for the image feature vector to the distribution of the training data feature vectors. An alert is produced if the image differs from the distribution of the training data feature vectors based on an analysis of the log likelihood.

### CROSS REFERENCES TO RELATED APPLICATIONS

This application claims the benefit and/or priority to German application 10 2024 208 360.7, filed Sep. 3, 2024, the content of which is incorporated by reference herein in its entirety.

### TECHNICAL FIELD

The present invention is concerned with a method, in particular a computer-implemented method, for monitoring the performance of a trained machine learning model, a monitoring system for monitoring a performance of a machine learning model, and a computer program to carry out the method according to the present invention and a computer-readable (storage) medium.

### BACKGROUND

Machine learning models, in particular models based on neural networks, are nowadays increasingly used in various technical fields and for various applications which is due to recent advancements in the field. One prominent example is their use in advanced driver assistance systems (ADAS) and for automated driving (AD).

Advanced driver assistance systems (ADAS) for vehicles are based on a processing of various data sensed by various ADAS sensors, such as radar, LiDAR, and ultrasonic sensors as well as cameras. By means of the ADAS sensors, information relating to an environment of the vehicle can be obtained, which in turn is used to realize various ADAS functions. ADAS functions on the one hand may include an assistance for the driver while control of the vehicle remains with the driver. On the other hand, depending on the level of automation, a full autonomously driving vehicle may be realized (AD). Known ADAS functions for instance are various methods for detecting and/or classifying objects and/or obstacles in the vicinity of the vehicle, methods for lane detection and/or lane departure, methods for rain detection or also various parking assistance functions.

However, machine learning based applications, especially also in the field of ADAS or AD, still also encounter substantial challenges. One problem is concerned with the fact that machine learning models are highly effective with analyzing data from seen data distributions, but do face problems with analyzing data from unseen data distributions. This is described in more detail, e.g., by M. Keser et al. in “Content disentanglement for semantically consistent synthetic-to-real domain adaptation”, 2021, available on arXiv, doi: arXiv: 2105.08704; in “Do imagenet classifiers generalize to imagenet?” by B. Recht et al., 2019, available on arXiv, doi: arXiv: 1902.10811; or in “Can you trust your model's uncertainty? evaluating predictive uncertainty under dataset shift” by Y. Ovadia et al., 2019, also available on arXiv, doi: arXiv: 1906.02530v2.

Referring to the example of automated driving applications, problems may particularly arise with respect to different driving scenarios, e.g., in case of unexpected or unfamiliar objects which is referred to a semantic shift in the following, or in case of varying environmental conditions, such as different lighting or weather conditions, which is referred to as covariate shift. All those varying conditions may pose substantial challenges to the performance and reliability of machine learning models.

There were various different solutions suggested in the prior art to improve performance and reliability of machine learning models with respect to semantic shifts.

During the training and testing of machine learning models, data sets are frequently split into training data sets and testing data sets. Subsequent to a training phase using the training data set only, the machine learning model's performance is assessed by feeding the testing data sets through the model. A performance score associated derived in this testing phase is presumed to generalize to unseen input data in real-world conditions. Because the training data sets and testing data sets are usually originated from the same data distribution, the generalization of the performance score does not accurately reflect the machine learning model's performance in the inference phase, where the model is deployed in a certain application. This is mainly due to the fact that the input data fed through the machine learning model in the inference phase deviates from the testing data set.

Some of the known approaches are summarized in “Anomalous example detection in deep learning: A survey”, published 2020 in IEEE Access 8:132330-132347; in “Deep learning for anomaly detection: A survey” by R. Chalapathy et al., 2019, available on arXiv, doi: 1901.03407v2; in “Out-of-distribution detection for automotive perception” by J. Nitsch et al, published 2021, available on arXiv, doi: arXiv: 2011.01413; or in Generalized out-of-distribution detection: A survey” by J. Yang et al, published 2021 and available on arXiv, doi: arXiv: 2110.11334v3.

Further suggested approaches include a Monte Carlo (MC) dropout, as disclosed e.g., in “Dropout as a Bayesian approximation: Representing model uncertainty in deep learning” published by Y. Gal et al in 2016, available on arXiv: doi: arXiv: 1506.02142, as well as several generative and reconstruction methods, and feature extraction techniques.

On the other hand, there were also few approaches suggested to reduce performance reductions of machine learning models due to covariate shifts, which are also referred to as distributional shifts or domain shifts. Coming back to the example of ADAS or AD, covariate shifts originate from changes in one or more environmental conditions, such as changes in the illumination, e.g. from day to night, or from varying weather conditions, such as rain, fog or snow. Machine learning models are predominantly trained with training data sets recorded in sunny and clear whether conditions and during the day. A non-exhaustive summary of the impact of covariate shifts on object detection was provided by F. Hell et al in “Monitoring perception reliability in autonomous driving: Distributional shift detection for estimating the impact of input data on prediction accuracy”, published 2021 in the Proceedings of the 5th ACM Computer Science in Cars Symposium, doi: https://doi.org/10.1145/3488904.3493382.

Overall, the methods suggested to address semantic and/or covariate shifts known from the literature, frequently rely on specific machine learning model architectures, on specific training data, are computationally expensive, require retraining of the models, and/or are tailored to one specific type of shifts, only. Hence, there is a need to improve how to address semantic and covariate shifts in input data for machine learning models.

### BRIEF DESCRIPTION OF DRAWINGS

This description includes drawings, wherein:

FIG. 1A illustrates semantic and covariate shifts in images; FIG. 1B illustrates semantic and covariate shifts in images; and FIG. 1C illustrates semantic and covariate shifts in images;

FIG. 2 shows a block diagram of a preferred embodiment of the present invention; and

FIG. 3 illustrates the working of the monitoring system of the present invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Accordingly, the technical problem underlying the present invention is to provide a reliable possibility to address semantic and covariate shifts for machine learning models.

This problem is solved by the methods, monitoring systems, computer programs, and the computer-readable (storage) medium described herein and according to the claims.

According to a first aspect of the present invention, the problem is solved by a method, in particular a computer-implemented method, for monitoring the performance of a trained machine learning model, the method comprising the steps of:
providing a trained vision foundation model;
providing a training data set used for training of the machine learning model;
for each training image of the training data set, determining a training data feature vector using the vision foundation model,
determining a distribution of the training data feature vectors;
receiving an image depicting a scene;
determining an image feature vector for the image using the vision foundation model;
computing a log likelihood for the image feature vector to the distribution of the training data feature vectors; and
providing an alert if the image differs from the distribution of the training data feature vectors based on an analysis of the log likelihood.

The suggested method provides a possibility for monitoring input data in the form of images depicting a scene with respect to semantic and/or covariate shifts. The method is preferably applied during the inference phase of the machine learning model. The input data for the machine learning model is as well processed by the method of the present invention. In case of a difference or deviation of the input data image from the training data set used during a training phase of the machine learning model prior to the inference phase, an alert is provided. The alert may indicate a likelihood of a performance decrease or reduced prediction accuracy due to a semantic and/or covariate shift of the input data image compared to the training data set images.

The machine learning model preferably is a machine learning model used for a computer vision application. Computer vision, in the context of the present invention, refers to the processing and analysis of images, e.g., recorded by cameras, in a wide variety of ways in order to understand their content or to extract various, especially geometric, information. For instance, the machine learning mode may be a model comprising at least one trained neural network. Without any restriction, the model may be any machine learning model capable of analyzing environmental information, preferably a model comprising at least a neural network, for instance an object detector, a segmentation network, a panoptic segmentation network or a lane detection network.

The feature vectors determined, i.e., the training data feature vectors and the image feature vectors, may be normalized before computing the log likelihood.

Advantageously, the present invention provides the ability to monitor a modified perception situation or to monitor rare scenarios by using a trained vision foundation model. Because vision foundation models are trained with huge amounts of data, they are highly sensitive to deviations potentially present in input data, and thus to the occurrence of semantic and/or covariate shifts that may impact the performance. If the vision foundation model may have a performance issue with a certain input image due to a deviation from a reference data distribution corresponding to a training data set, the machine learning model will most likely face the same performance issue, as the amount of training data used for the machine learning model is typically lower than that used for training of the known vision foundation model.

In contrast to prior art solutions mentioned, the present invention allows to monitor both, semantic and/or covariate shifts. Moreover, no specific fine-tuning of the monitoring system is needed. Instead, it is suggested to utilize an already trained vision foundation model, making the suggested solution computationally efficient and cost efficient.

The alert provided may be subject to further processing steps. For the example of ADAS and AD, for instance, subsequent ADAS functions or an autonomous driving operation may be controlled by the output of the suggested monitoring method. Generally, the availability or level of automation may depend on the alerts provided or on the presence of semantic and/or covariate shifts identified in the input data for the machine learning model.

According to a preferred embodiment of the method of the present invention, the distribution is determined by a distribution determination model, preferably by using a mixture model, e.g., a gaussian mixture model, or by applying a Mises-Fisher distribution. The distribution determination model is directly applied to the features extracted from the training data set by using the trained vision foundation model.

It is of advantage, if determining the distribution further comprises applying an expectation-maximation algorithm. The expectation-maximation algorithm is used to determine optical parameters of the distribution.

It is further of advantage, if determining the distribution further comprises applying an Akaike information criterion, applying a Bayesian information criterion or providing a validation data set and computing a log-likelihood of validation data feature vectors to the distribution of the training data feature vectors. This embodiment serves to optimally balance the distribution complexity and fitting accuracy.

The trained vision foundation model preferably is any off-the-shelf available vision foundation model. Advantageously, the vision foundation model is a Contrastive Language-Image Pretraining model (CLIP model), a DINO model, a DINOv2 model, a Grounding DINO model, a Grounded Language-Image Pre-training model (GLIP model), an Eva-CLIP model, a SAM model, or a SAMv2 model.

The CLIP model was described by A. Radford et al in “Learning transferable visual models from natural language supervision” from 2021, available on arXiv, doi: arXiv: 2103.00020v1. The DINO model was described by M. Caron et al., in “Emerging properties in self-supervised vision transformers” in 2021, available on arXiv, doi: arXiv: 2104.14294. Details about the DINOv2 model may be found in “DINOv2: Learning Robust Visual Features without Supervision” by M. Oquab et al from 2023, available on arXiv, doi: arXiv: 2304.07193. The Grounding DINO model in turn was described in “Grounding DINO: Marrying DINO with Grounded Pre-Training for Open-Set Object Detection” by S. Liu et al., available on arXiv: 2303.05499.

Similarly, details about the GLIP model may be found in “Grounded Language-Image Pre-training”, published 2021 by L. H. Li et al, available on arXiv, doi: arXiv: 2112.03857, details about the Eva-CLIP model in “EVA-CLIP: Improved Training Techniques for CLIP at Scale” by Q. Sun et al, published 2023 and available on arXiv, doi: arXiv: 2303.15389v1; details about the SAM in “Segment Anything” by A. Kirillov et al., available on arXiv, doi: arXiv: 2304.02643, and finally, details about the SAMv2 were described in “SAM 2: Segment Anything in Images and Videos”, published 2024 by N. Ravi et al, available as well on arXiv, doi: arXiv: 2408.00714.

The trained vision foundation model in principle is used for input monitoring of a machine learning model, preferably a machine learning model used for an ADAS or for an AD application. Trained vision foundation models, in particular those listed above, advantageously are capable of understanding rich semantic context and to capture subtle semantic differences within images. They have a strong performance across a wide range of visual tasks and the ability to generalize to novel scenarios. Mostly, they are trained on extensive training data sets, which diminishes the need for extensive fine-tuning.

Another preferred embodiment of the suggested method comprises that the log likelihood of the image feature vector is transformed into a normalized confidence score. This leads to a better interpretability of the computed log likelihood. Preferably, the log likelihood is bounded between zero and one.

It is of advantage, if the transformation is carried out by a shifting and scaling of the log likelihood. This procedure ensures that the highest likelihood that the image feature vector belongs to the determined distribution is the maximum value, and the minimum value of the normalized confidence score refers to the lowest confidence or probability that the image feature vectors belongs to the determined distribution.

It is further of advantage, if the analysis of the log likelihood of the image feature vector comprises a comparison of the corresponding normalized confidence score with a predetermined threshold. The threshold corresponds to a certain probability that the image feature vector and thus the input image belongs to the determined distribution or the training data set. In case of a deviation, i.e. the presence of a semantic and/or covariate shift, the normalized confidence score will likely be below the threshold.

Accordingly, it is also of advantage, if the alert is provided if the normalized confidence score is smaller than the threshold.

The problem underlying the present invention is further solved by a monitoring system for monitoring a performance of a trained machine learning model comprising at least one environmental sensor and a memory storing executable instructions for execution by the one or more processors (e.g., any type of electronic processing device such as a microprocessor), the executable instructions comprising instructions for performing a method according to the embodiments described. The environmental sensor preferably is a camera recording images depicting a scene with at least one object represented in the scene.

The method of the present invention for monitoring the performance of a trained machine learning model is preferably used in an advanced driver assistance system or for an autonomous vehicle. Preferably, the method is used to monitor the performance of a machine learning model used to analyze images depicting a scene in which at least object is presented, especially with respect to the occurrence of semantic and/or covariate shifts which may induce performance issues of the machine learning model.

Using the input monitoring method or system for ADAS or AD, significant or critical deviations for inputs of used machine learning models from training and testing conditions may be detected. This enhances the operational safety and reliability for the corresponding vehicles, especially in dynamic environments. In principle, the invention provides added safety functionality for vehicles by monitoring and/or detecting unexpected or unfamiliar objects and environmental conditions, thereby preventing potential accidents caused by anomalies that the trained machine learning model may fail to recognize.

The problem underlying the present invention is further solved by a computer program comprising instructions, which, when the program is executed by a computer, cause the computer to carry out the method of any of the embodiments described and by a computer-readable (storage) medium comprising instructions executable by at least one processor to perform the method of any of the embodiments described or on which the computer program according to the present invention is stored.

The invention and its preferred embodiments will be further described by the subsequent drawings.

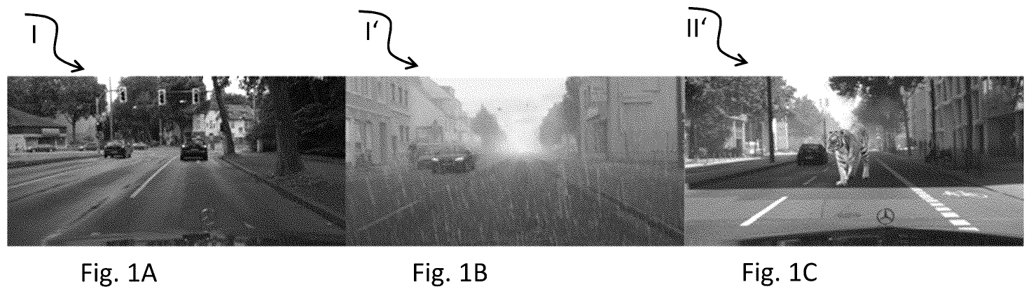

FIG. 1A, FIG. 1B, and FIG. 1C illustrate semantic and covariate shifts in images;

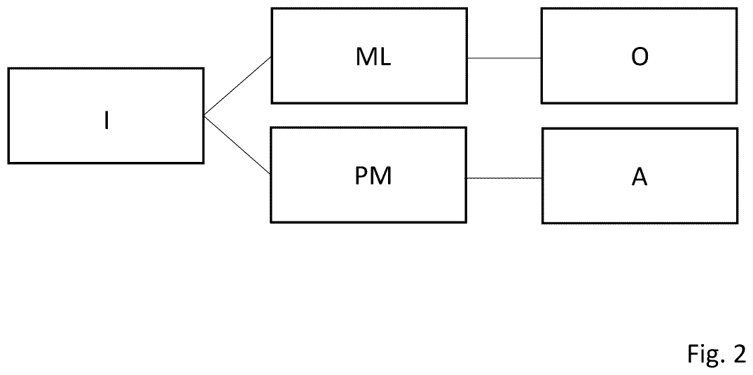

FIG. 2 shows a block diagram of a preferred embodiment of the present invention; and

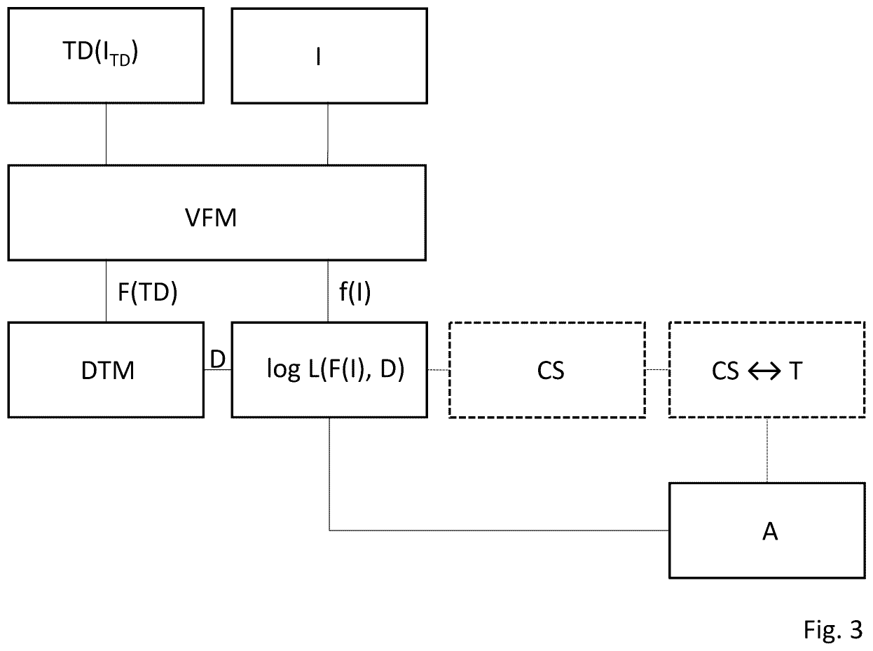

FIG. 3 illustrates the working of the monitoring system of the present invention.

In the figures, the same elements are always provided with the same reference symbols.

Without limiting the scope of the invention, the subsequent description will make use of the exemplary application of the present invention to ADAS or AD and to systems and devices that implement ADAS and AD.

FIG. 1A, FIG. 1B, and FIG. 1C illustrate semantic and covariate shifts in image data. FIG. 1A, FIG. 1B, and FIG. 1C refer to an image I depicting a scene in which several objects are represented, e.g., two vehicles on different lanes of a road. The image I was recorded during the day and having sunny weather conditions. A similar image l′ being subject to a covariate shift is depicted in FIG. 1B. The image depicts a scene with a road and a vehicle, but the image I′ has been recorded under low visibility conditions in a rainy environment. On the other hand, a semantic shift refers to unexpected or unfamiliar objects depicted in an image. An example is provided by image l″ shown in FIG. 1C, in which an object in the form of a tiger is visible on the road, which corresponds to a rare or unusual scenario.

Machine learning models typically face performance issues if subjected to input data having covariate and/or semantic shifts, or which deviate differ from data sets used for training and/or testing of the respective model. This problem is addressed by the present invention.

FIG. 2 shows a block diagram of a preferred embodiment of the method according to the present invention. The method as well as the monitoring system suggested are capable of observing inputs of machine learning models to their perception functions. If the input data deviates from known distributions of training data sets used for training of the machine learning models, an alert is provided, e.g., about a potential of performance failure of the machine learning model.

An image I (input data) is fed to a trained machine learning model ML which is embodied to provide an output O based on the input I. The machine learning model may, for example, be an object detector used to determine objects in a surrounding of a vehicle. Various ADAS functions or driving functions may rely on the results of the object detector and use the results.

In order to monitor the performance of the machine learning model ML, the image I is as well provided to the performance monitoring system PM according to the present invention which provides an alert A in case the image I differs from a training data set used to train the machine learning model ML prior to the inference phase. As such, the present invention provides an input monitoring method and system.

The working principle of the suggested method or system PM is explained in more detail referring to FIG. 3. The suggested method makes use of a trained vision foundation model VFM, and the training data set TD comprising multiple training images I_{DT} used to train the machine learning model ML for which the performance is to be monitored.

First, the training data set DT (I_{DT1}, I_{DT2}, . . . . I_{DTn}) is provided to a chosen trained vision foundation model VDM via which features f(DT) contained in the training data set are extracted or determined. The determined features are summarized by corresponding feature vectors F(f_{DT1}, f_{DT2}, . . . f_{DTn}), where each feature vector f_{DT1} corresponds to one training data image I_{DTI}. The feature vectors f may optionally further be normalized to ensure consistent scale across the training data set TD.

Subsequently, a distribution D of the associated training data feature vectors F is determined. For the embodiment shown in FIG. 3, the distribution D is determined by the distribution determination model DTM.

For instance, the distribution D may be determined by modelling the extracted features f (TD) by using a Gaussian mixture model (GMM) of K Gaussians:

$$p ( {f}_{TDi} \vert Θ ) = {{\sum }_{k = 1}}^{K} {π}_{k} 𝒩 ( {f}_{TDi} \vert {μ}_{k} , {\sum }_{k} )$$

First, the training data set DT (I_{DT1}, I_{DT2}, . . . . I_{DTn}) is provided to a Therein, Θ={π₁, . . . , π_{K}, μ₁, Σ₁, . . . , Σ_{K}} represents the GMM parameters, π_{K} is the mixing coefficient

$$( with {\sum }_{k = 1}^{K} {π}_{k} = 1 ensuring a valid probability distribution ) ,$$

μₖ the mean vector and Σₖ the covariance matrix of the k-th Gaussian component.

Optionally, the parameters Θ of the GMM may be derived from the training feature vectors F using the Expectation-Maximization algorithm. The determination of distribution D may optionally also further comprise applying the Akaike Information Criterion to determine the model's number of components K. The criterion is applied by testing a series of K values on training and testing images I that are representative of the training data set DT.

It shall be noted that the distribution may also be determined by different approaches, especially by using other distribution determination models, e.g. the Mises-Fisher distribution.

During the inference phase, images I are provided to the machine learning model ML and to the performance monitoring system PM, as outlined in connection with FIG. 2.

Assuming that for multiple input images I, some of the images will be in-distribution images Iᵢₙ, corresponding the training data set TD, while others are so called out-of-distribution images Iₒᵤₜ, meaning that they contain a semantic and/or covariate shift. Then, an image distribution X of the images is given by [symbol] =Iᵢₙ ∪Iₒᵤₜ with corresponding feature vectors [symbol] = [symbol] ᵢₙ ∪ [symbol] ₒᵤₜ.

For a new image I ∈ [symbol] , first an image feature vector f(I) is determined by processing the image I through the trained vision foundation model VFM as well. This feature vector f(I) may as well be normalized.

Subsequently, a log likelihood of the image feature vector f(l) to the distribution D is computed as

$$log p ( f ( I ) \vert Θ ) = log ( {{\sum }_{k = 1}}^{K} {π}_{k} 𝒩 ( f ( I ) \vert {μ}_{k} , {\sum }_{k} ) )$$

where

$$Θ = {\{ {π}_{k} , {μ}_{k} , {\sum }_{k} \}}_{k = 1}^{K}$$

is related to the distribution D as above.

The computed log likelihood is a measure for a probability that the image feature vector f(I) refers to the training data distribution D, reflecting its alignment with the in-distribution images lin. Thus, the computed log likelihood may by analyzed in order to provide alert A if the image I differs from the distribution D of the training data feature vectors F(TD).

According to an optional, preferred embodiment, the log likelihood is transformed into a normalized confidence score CS. That way, the interpretability of the computed log likelihood is increased.

The transformation may for instance be carried out by a shifting and scaling of the log likelihood:
1. Shifting: First, the log likelihood is adjusted to ensure all values are non-negative by computing a shifted log likelihood [symbol] for each data point as

$${ℓ}^{′} ( f ) = log p ( f ( I ) \vert Θ ) - {min}_{{f}^{′} ∈ ℱ} log p ( f ( I ) \vert Θ )$$

2. Scaling: Subsequently, the shifted values are normalized to a [0, 1] interval. The normalized confidence score CS is then given by:

$$CS = \frac{{ℓ}^{′} ( f ( I ) )}{{max}_{f ∈ ℱ} {ℓ}^{′} ( f ( TD ) )} ,$$

where f(I) is the feature vector belonging to image I and

$${max}_{f ∈ ℱ} {ℓ}^{′}$$

(f) is the maximum shifted log likelihood across the training data set TD. This ensures that the highest log likelihood is scaled to 1, corresponding to the highest confidence, while the minimum corresponds to the lowest confidence.

Thus, the normalized confidence score CS for each Image I is derived from the normalized log likelihoods, with higher scores indicating a greater probability of the image I to belong to the distribution D of the training data set TD.

In order to determine whether an alert A needs to be provided, the normalized confidence score CS may be compared with a predetermined threshold T. In case the normalized confidence score CS succeeds threshold T, the alert A is provided.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A method, in particular a computer-implemented method, for monitoring the performance of a trained machine learning model, the method comprising:
providing a trained vision foundation model;
providing a training data set used for training of the machine learning model;
for each training image of the training data set determining a training data feature vector using the vision foundation model,
determining a distribution of the training data feature vectors;
receiving an image depicting a scene;
determining an image feature vector for the image using the vision foundation model;
computing a log likelihood for the image feature vector to the distribution of the training data feature vectors;
providing an alert if the image differs from the distribution of the training data feature vectors based on an analysis of the log likelihood.

2. The method according to claim 1,
wherein the distribution is determined by a distribution determination model, by using a mixture model, a gaussian mixture model, or by applying a Mises-Fisher distribution.

3. The method according to claim 2,
wherein determining the distribution further comprises applying an expectation-maximation algorithm.

4. The method according to claim 2,
wherein determining the distribution further comprises applying an Akaike information criterion, applying a Bayesian information criterion, or providing a validation data set and computing a log-likelihood of validation data feature vectors to the distribution of the training data feature vectors.

5. The method according to claim 1,
wherein the vision foundation model is a CLIP model, a DINO model, a DINOv2 model, a Grounding DINO model, a GLIP model, an Eva-CLIP model, a SAM model, or a SAMv2 model.

6. The method according to claim 1,
wherein the log likelihood of the image feature vector is transformed into a normalized confidence score.

7. The method according to claim 6,
wherein the transformation is carried out by a shifting and scaling of the log likelihood.

8. The method according to claim 6,
wherein the analysis of the log likelihood of the image feature vector comprises a comparison of the corresponding normalized confidence score with a predetermined threshold.

9. The method according to claim 8,
wherein the alert is provided if the normalized confidence score is smaller than the threshold.

10. The method according to claim 1, wherein the trained machine learning model is used in an ADAS system or for an autonomous vehicle.

11. A monitoring system for monitoring a performance of a trained machine learning model comprising at least one environmental sensor and a memory storing executable instructions for execution by one or more processors, the executable instructions comprising instructions for performing a method according to claim 1.

12. A computer program comprising instructions, which, when the program is executed by a computer, cause the computer to carry out the method of claim 1.

13. A computer-readable medium comprising instructions executable by at least one processor to perform the method of claim 1.
